(19) United States
(12) Patent Application Publication
(10) Pub. No.: US 2010/0016478 A1
(43) Pub. Date: Jan. 21, 2010

(54) PAPER SIZE MIXTURES

(75) Inventors: Andreas Brockmeyer, Bickenbach (DE); Roland Ettl, Altussheim (DE); Rainer Dyllick-Brenzinger, Neustadt (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/518,312

(22) PCT Filed: Dec. 11, 2007
(86) PCT No.: PCT/EP2007/063681

§ 371 Date: Jun. 9, 2009

(30) Foreign Application Priority Data
Dec. 20, 2006 (EP) 06126699.5

(51) Int. Cl. C08L 3/02; C08F 2/16; C08K 5/15; C08L 29/04; C08L 39/06; C08L 33/00; C08G 67/00; C08L 89/00; C08L 33/06; C08L 55/00

(52) U.S. Cl. 524/17; 524/800; 524/112; 524/557; 524/548; 524/556; 524/612; 524/47; 524/560; 524/565

(57) ABSTRACT

Paper size mixtures comprising a reactive size dispersed in water and a polymer, which are obtainable by mixing
(a) an aqueous dispersion of a reactive size whose dispersed particles have a mean particle diameter of less than 500 nm, the dispersion being obtainable by emulsifying at least one reactive size in water in the presence of at least one surfactant, and
(b) at least one emulsion polymer and/or at least one water-soluble polymer which does not have a dispersing effect with respect to reactive sizes and/or a water-dispersible polymer,
   and use of said paper size mixtures for the engine sizing and surface sizing of paper and paper products.

The invention relates to paper size mixtures comprising a reactive size dispersed in water and a polymer.

DE-A 195 12 399 discloses paper size mixtures which comprise a finely divided aqueous dispersion of a C₁₄- to C₂₂-alkyldiketene as a first component and a finely divided aqueous polymer dispersion as a second component, which is a size for paper. The first component is prepared by dispersing alkyldiketenes in water in the presence of cationic starch which has an amylopectin content of at least 95%, preferably from 98 to 100%. The dispersing of the alkyldiketenes can additionally be effected in the presence of ligninsulfonic acid, condensates of naphthalenesulfonic acid and formaldehyde, polymers comprising styrenesulfonic acid groups or alkali metal and/or ammonium salts thereof. The mean particle diameter of the alkyldiketenes dispersed in water is from 0.5 to 2.5 μm, preferably from 0.8 to 1.5 μm. According to the information in the examples it is always above 1 μm. The mixtures are prepared by mixing an alkyldiketene dispersion with a polymer dispersion or by emulsifying alkyldiketenes at a temperature of at least 70° C. in a mixture which consists of aqueous suspensions of cationic starch having an amidopectin content of at least 98% and finely divided, aqueous polymer dispersions. Such mixtures consist of two different particle types, namely of particles of alkyldiketene and particles of emulsion polymer.

WO 2004/037867 discloses aqueous polymer dispersions which comprise alkyldiketenes and are obtainable by miniemulsion polymerization of hydrophobic monoethylenically unsaturated monomers in the presence of alkylketene dimers. A single particle dispersed in water comprises both alkylketene dimer and hydrophobic polymer. The mean particle diameter is in the range of from 50 to 500 nm, preferably from 50 to 200 nm. Polymer dispersions which have a corresponding composition but comprise alkylenylsuccinic anhydrides instead of alkylketene dimers are disclosed in WO 2005/070912. They are prepared by polymerization of hydrophobic monomers by a miniemulsion polymerization method in the presence of alkylsuccinic anhydrides and, if appropriate, additionally alkylketene dimers.

WO 2004/022847 discloses the use of polymers comprising vinylamine units as promoters for the engine sizing of paper. For example, aqueous dispersions which comprise stearyldiketene, cationic starch and polyvinylamine are described therein.

The prior EP application 06 115 714.5 relates to a process for the preparation of aqueous polymer dispersions comprising at least one lipophilic active substance by emulsion polymerization of ethylenically unsaturated monomers in an aqueous medium in the presence of at least one lipophilic active substance,
(i) at least one lipophilic active substance which has a water solubility of not more than 5 g/l (determined at 25° C. and 1013 mbar) and a melting point below 130° C. being emulsified in an aqueous solution which comprises at least one dispersion stabilizer, with formation of an aqueous dispersion of the active substance having a mean particle size of not more than 1000 nm, preferably not more than 500 nm, and
(ii) subjecting a monomer composition which comprises at least 80% by weight of a neutral monoethylenically unsaturated monomer emulsifiable in water to an emulsion polymerization in the aqueous dispersion of the active substance obtained according to (i).

Suitable lipophilic active substances are, inter alia, alkyldiketenes and alkylsuccinic anhydrides. For example, for the use of alkylketene dimer as active substance, the particles of the aqueous polymer dispersions comprise both alkylketene dimer and emulsion polymer and have a mean particle diameter of not more than 1000 nm.

It is the object of the invention to provide further products for paper sizing which result in as rapid development as possible of the size.

The object is achieved, according to the invention, by paper size mixtures comprising a reactive size dispersed in water and a polymer, wherein said mixtures are obtainable by mixing
(a) a aqueous dispersion of a reactive size whose dispersed particles have a mean particle diameter of less than 500 nm, the dispersion being obtainable by emulsifying at least one reactive size in water in the presence of at least one surfactant, and
(b) at least one emulsion polymer and/or at least one water-soluble polymer which does not have a dispersing effect with respect to reactive sizes and/or a water-dispersible polymer.

Particularly preferred paper size mixtures are those where the component (a) of the mixtures is an aqueous dispersion of a reactive size whose dispersed particles have a mean particle diameter of not more than 300 nm. The component (a) of the mixtures comprises, as reactive size, an aqueous dispersion of an alkylketene dimer and/or of an alkenylsuccinic anhydride having a mean particle size of the dispersed particles of, for example, from 30 to 300 nm.

The weight ratio of components (a) and (b) in the mixture is, for example, from 1:100 to 100:1 and is preferably in the range from 1:20 to 20:1. Particularly preferred paper size mixtures are those which comprise, as component
(a) an aqueous dispersion of an alkylketene dimers which is emulsified with the aid of a cationic, anionic and/or nonionic surfactant, and comprise as component
(b) at least one emulsion polymer having a mean particle diameter of not more than 100 nm.

Preferred alkylketene dimers (“AKD”) are C₁₄- to C₂₂-alkyl- or alkenyl diketenes. They are prepared, for example, from the corresponding carboxylic acid chlorides by elimination of hydrogen chloride with tertiary amines. The ketene dimers which can be used according to the invention carry saturated or unsaturated, branched or cyclic hydrocarbon radicals. Examples of such alkylketene dimers are tetradecyldiketene, hexadecyldiketene, octadecyldiketene, docosyldiketene, palmityldiketene, oleyldiketene, stearyldiketene and behenyldiketene. Stearyldiketene, palmityldiketene, oleyldiketene, behenyldiketene, isostearyidiketene or mixtures of alkyldiketenes, for example mixtures of behenyldiketene and stearyidiketene or mixtures of stearyidiketene and palmityldiketene, are preferably used.

Alkenylsuccinic anhydrides are described in detail, for example, in U.S. Pat. No. 3,102,064, EP-A 0 609 879 and EP-A 0 593 075. All alkenylsuccinic anhydrides which have been described to date in the literature as engine sizes for paper are suitable according to the invention as active substance, either alone or in combination with alkyldiketenes. Suitable alkylsuccinic anhydrides comprise an alkyl radical having at least 6 carbon atoms, preferably a C₁₄- to C₂₄-olefin radical, in the alkyl group. Particularly preferred alkenylsuccinic anhydrides comprise 16 to 22, in general 16 to 18, carbon atoms in the alkenyl group. They may comprise linear, additionally unsaturated or branched alkenyl groups. Alkenylsuccinic anhydrides are obtainable, for example, from α-olefins, which are first isomerized. A mixture of different isomers is obtained, which is then reacted with maleic anhydride by an ene reaction to give succinic anhydrides. Alkenyl succinic anhydrides are prepared according to EP-A 0 593 075 by reaction of propylene or n-butylene oligomers with maleic anhydride. Examples of this group of reactive sizes are decenylsuccinic anhydride, dodecenylsuccinic anhydride, octenylsuccinic anhydride and n-hexadecenylsuccinic anhydride. The individual isomeric succinic anhydride may have different sizing effects. Thus, for example, 2- and 3-hexadecenyl-succinic anhydrides are not as effective as engine sizes as the isomeric 4-, 5-, 6-, 7- and 8-hexadecenylsuccinic anhydrides.

For the preparation of component (a) of the mixtures according to the invention, the suitable reactive sizes are dispersed in water. They are preferably first melted and then emulsified as a melt in water in the presence of a surfactant which acts as a dispersion stabilizer. The emulsification of the reactive sizes can be effected, for example, by high-pressure emulsification in the apparatuses known for this purpose, with the aid of the action of ultrasound or by the action of strong shear forces, for example with the aid of an Ultra Turrax® apparatus.

During the emulsification process, the temperature of the system may be from 0 to 130° C., preferably up to 100° C. In general, the reactive sizes are emulsified in the temperature range from 5 to 95° C. in water which comprises at least one surfactant. If temperatures above 100° C. are used, the emulsification step is effected under superatmospheric pressure in pressure-tight apparatuses. During the emulsification, the temperature should be at least 5° C., preferably at least 10° C., above the melting point or above the beginning of the softening range of the respective reactive size. After the emulsification, the resulting oil-in-water emulsion of the reactive site is cooled, in general to the respective ambient temperature, for example from 10 to 30° C. Either an emulsion is obtained, if the melting point of the reactive size is above the temperature of the system, or an aqueous dispersion is obtained if the emulsified particles of the reactive size are present in the solid state of aggregation. Preferably the reactive sizes are alkylketene dimers.

The mean diameter of the emulsified particles of the reactive size is less than 500 nm, preferably not more than 300 nm and is in general in the range from 30 to 300 nm, in particular from 40 to 200 nm. The particle sizes of the emulsified reactive sizes which are stated here are weight average particle sizes as can be determined by dynamic light scattering. Methods for this purpose are familiar to the person skilled in the art, for example from H. Wiese in D. Distler, Wässrige Polymerdispersionen, Wiley-VCH 1999, section 4.2.1, page 40 et seq. and literature cited there and H. Auweter, D. Horn, J. Colloid Interf. Sci. 105 (1985) 399, D. Lilge, D. Horn, Colloid Polym. Sci. 269 (1991) 704 or H. Wiese, D. Horn, J. Chem. Phys. 94 (1991) 6429.

In order to obtain as stable as possible a dispersion or emulsion of the reactive size, it is preferably emulsified in the presence of at least one surfactant as a dispersion stabilizer. In general, at least one surfactant is first dissolved in water and only thereafter is the molten size added. However, the surfactant can also be added during the emulsification or thereafter. The addition of the surfactant can be carried out continuously, stepwise or all at once. A dispersion which comprises, for example, from 0.01 to 20% by weight, preferably from 0.1 to 10% by weight and in general from 0.2 to 5% by weight of at least one surfactant is obtained.

The content of reactive size in the aqueous dispersion may be, for example, from 1 to 60% by weight, preferably from 10 to 50% by weight. In general, it is in the range from 15 to 30% by weight.

The surfactants suitable as a dispersion stabilizer may be, for example, cationic, anionic, amphoteric or nonionic. It is possible to use a surfactant from a single group of said surfactant or mixtures of surfactants which are compatible with one another, i.e. which are stable alongside one another in an aqueous medium and do not form precipitates, for example mixtures of at least one nonionic and at least one anionic surfactant, mixtures of at least one nonionic and at least one cationic surfactant, mixtures of at least two cationic surfactants, mixtures of at least two anionic surfactants or mixtures of at least two nonionic surfactants. Apart from a surfactant, a protective colloid and/or a dispersant can additionally be used as a dispersion stabilizer. For example, mixtures of at least one surfactant and at least one dispersant or mixtures of at least one surfactant, at least one dispersant and at least one protective colloid are suitable. Mixtures which comprise two or more dispersion stabilizers are preferred.

For example, all surface-active agents are suitable as surfactants. Examples of suitable nonionic surface-active substances are ethoxylated mono-, di- and trialkylphenols (degree of ethoxylation: from 3 to 50, alkyl radical: C₃-C₁₂) and ethoxylated fatty alcohols (degree of ethoxylation: from 3 to 80; alkyl radical: C₈-C₃₆). Examples of these are the Lutensol® brands of BASF AG or the Triton® brands of Union Carbide. Ethoxylated linear fatty alcohols of the general formula

n-CₓH₂ₓ₊₁—O(CH₂CH₂O)_{y}—H,

where x is an integer in the range from 10 to 24, preferably in the range from 12 to 20, are particularly preferred. The variable y is preferably an integer in the range from 5 to 50, particularly preferably from 8 to 40. Ethoxylated linear fatty alcohols are usually present as a mixture of different ethoxylated fatty alcohols having different degrees of ethoxylation. In the context of the present invention, the variable y is the average value (number average). Suitable nonionic surface-active substances are furthermore copolymers, in particular block copolymers, of ethylene oxide and at least one C₃-C₁₀-alkylene oxide, e.g. three-block copolymers of the formula

RO(CH₂CH₂O)_{y1}—(BO)_{y2}-(A-O)ₘ—(B′O)_{y3}—(CH₂CH₂O)_{y4}R′.

where m is 0 or 1, A is a radical derived from an aliphatic, cycloaliphatic or aromatic diol, e.g. ethane-1,2-diyl, propane-1,3-diyl, butane-1,4-diyl, cyclohexane-1,4-diyl, cyclohexane-1,2-diyl or bis(cyclohexyl)methane-4,4′-diyl, B and B′, independently of one another, are propane-1,2-diyl, butane-1,2-diyl or phenylethanyl, y2 and y3, independently of one another, are a number from 2 to 100, y1 and y4, independently of one another, are a number from 2 to 100, the sum y1+y2+y3+y4 preferably being in the range from 20 to 400, which corresponds to a number average molecular weight in the range from 1000 to 20 000. A is preferably ethane-1,2-diyl, propane-1,3-diyl or butane-1,4-diyl. B is preferably propane-1,2-diyl.

In addition to the nonionic surfactants, other suitable surface-active substances are anionic and cationic surfactants. They can be used alone or as a mixture. However, a precondition for this is that they are compatible with one another. This precondition applies, for example, to mixtures of in each case one class of compounds and to mixtures of nonionic and anionic surfactants and mixtures of nonionic and cationic surfactants. Examples of suitable anionic surface-active agents are sodium laurylsulfate, sodium dodecylsulfate, sodium hexadecylsulfate and sodium dioctylsulfosuccinate.

Examples of cationic surfactants are quaternary alkylammonium salts, alkylbenzylammomnium salts, such as dimethyl-C₁₂- to C₁₋₈-alkylbenzylammonium chlorides, primary, secondary and tertiary fatty amine salts, quaternary amidoamine compounds, alkylpyridinium salts, alkylimidazolinium salts and alkyloxazolinium salts.

Anionic surfactants, such as, for example, (optionally alkoxylated) alcohols which are esterified with sulfuric acid and which are generally used in a form neutralized with alkali are particularly preferred. Further customary emulsifiers are, for example, sodium alkanesulfonates, sodium alkylsulfates, such as, for example, sodium laurylsulfate, sodium dodecylbenzenesulfonate, and sulfosuccinic esters. Esters of phosphoric acid or of phosphorous acid and aliphatic or aromatic carboxylic acid can furthermore be used as ionic emulsifiers. Customary emulsifiers are described in detail in the literature, cf. for example M. Ash, I. Ash, Handbook of Industrial Surfactants, Third Edition, Synapse Information Resources Inc.

The component (a) of the paper size mixtures is preferably obtainable by emulsifying a reactive size in the presence of a surfactant and at least one dispersant and/or at least one protective colloid. Frequently used dispersants are, for example, condensates of naphthalenesulfonic acid and formaldehyde, condensates of a salt of naphthalene-sulfonic acid or ligninsulfonic acid or salts thereof. Preferred salts of naphthalene-sulfonic acid and of ligninsulfonic acid are the products completely or partly neutralized with sodium hydroxide solution, potassium hydroxide solution, ammonia or calcium hydroxide. However, amphiphilic polymers or nanoparticles comprising water-insoluble organic polymers or comprising water-insoluble inorganic compounds (Pickering effect) can also be used as dispersants. Stabilizers of this type are, for example, nanoscale silica and nanoscale alumina.

The component (a) of the mixtures according to the invention is therefore obtainable by emulsifying a reactive size in the presence of a surfactant and at least one dispersant from the group consisting of the condensates of naphthalenesulfonic acid and/or the salts thereof and formaldehyde, ligninsulfonic acid or the salts thereof, amphiphilic polymers and/or nanoparticles comprising organic polymers or of inorganic compounds.

The amphiphilic polymers used as dispersant may have an average molar mass M_{w} of, for example, from 1000 to 100 000. They are used in combination with a surfactant as a dispersion stabilizer. Examples of amphiphilic polymers are copolymers which comprise units of
(i) hydrophobic monoethylenically unsaturated monomers and
(ii) monoethylenically unsaturated carboxylic acids, monoethylenically unsaturated sulfonic acids, monoethylenically unsaturated phosphonic acids or mixtures thereof and/or basic monomers.

Suitable hydrophobic monoethylenically unsaturated monomers for the preparation of the amphiphilic polymers are, for example,
(i) styrene, methylstyrene, ethylstyrene, acrylonitrile, methacrylonitrile, C₂- to C₁₈-olefins, esters of monoethylenically unsaturated C₃- to C₅-carboxylic acids and monohydric alcohols, vinyl alkyl ethers, vinyl esters or mixtures thereof. From this group of monomers, isobutene, diisobutene, styrene and acrylates, such as ethyl acrylate, isopropyl acrylate, n-butyl acrylate and sec-butyl acrylate, are preferably used.

The amphiphilic copolymers preferably comprise, as hydrophilic monomers,
(ii) acrylic acid, methacrylic acid, maleic acid, maleic anhydride, itaconic acid, vinylsulfonic acid, 2-acrylamidomethylpropanesulfonic acid, acrylamidopropane-3-sulfonic acid, 3-sulfopropyl acrylate, 3-sulfopropyl methacrylate, styrenesulfonic acid, vinylphosphonic acid and mixtures thereof incorporated in the form of polymerized units. The acidic monomer may be present in the form of the free acids or in partly or completely neutralized form.

Further suitable hydrophilic monomers are basic monomers. They can be polymerized with the hydrophobic monomers (i) alone or as a mixture with abovementioned acidic monomers. The use of mixtures of basic and acidic monomers results in the formation of amphoteric copolymers which are anionically or cationically charged, depending on the molar ratio of the acidic to basic monomers incorporated in the form of polymerized units in each case.

Basic monomers are, for example, di-C₁- to C₂-alkylamino-C₂- to C₄-alkyl(meth)acrylates or dialiyldimethylammonium chloride. The basic monomers may be present in the from of the free bases or of the salts with organic or inorganic acids or in the form quaternized with alkyl halides. The salt formation or the quaternization, in which the basic monomers become cationic, can be effected partly or completely. Examples of such compounds are dimethylaminoethyl methacrylate, diethylaminoethyl methacrylate, dimethylaminoethyl acrylate, diethylaminoethyl acrylyate, dimethylaminopropyl methacrylate, dimethylaminopropyl acrylate, diethylaminopropyl methacrylate, diethylaminopropyl acrylate and/or dimethylaminoethylacrylamide, dimethylaminoethylmethacrylamide, dimethylaminopropylacrylamide, dimethylaminopropylmethacrylamide and/or diallyldimethylammonium chloride.

If the amphiphilic copolymers are not sufficiently water-soluble in the form of the free acid they are used in the form of water-soluble salts; for example, the corresponding alkali metal, alkaline earth metal and ammonium salts are used. These salts are prepared, for example, by partial or complete neutralization of the free acid groups of the amphiphilic copolymers with bases; for example, sodium hydroxide solution, potassium hydroxide solution, magnesium oxide, ammonia or amines, such as triethanolamine, ethanolamine, morpholine, triethylamine or butylamine, are used for the neutralization. The acid groups of the amphiphilic copolymers are preferably neutralized with ammonia or sodium hydroxide solution. The water solubility of basic monomers or of copolymers which comprise such monomers incorporated in the form of polymerized units can on the other hand be increased by partial or complete neutralization with a mineral acid, such as hydrochloric acid or sulfuric acid, or by addition of an organic acid, such as acetic acid or p-toluenesulfonic acid. The molar mass of the amphiphilic copolymers is, for example, from 1000 to 100 000 and is preferably in the range from 1500 to 10 000. The acid numbers of amphiphilic copolymers are, for example, from 50 to 500, preferably from 150 to 350, m KOH/g of polymer.

Preferred amphiphilic copolymers are those which comprise
(i) from 95 to 45% by weight of isobutene, diisobutene, styrene or mixtures thereof and
(ii) from 5 to 55% by weight of acrylic acid, methacrylic acid, maleic acid, monoesters of maleic acid or mixtures thereof
   incorporated in the form of polymerized units, such copolymers generally used as dispersants being those which comprise
(i) from 45 to 80% by weight of styrene,
(ii) from 55 to 20% by weight of acrylic acid and, if appropriate,
(iii) additionally further monomers
   incorporated in the form of polymerized units. The copolymerize, can, if appropriate, comprise polymerized units of maleic monoesters as further monomers (iii). Such copolymers are obtainable, for example, by copolymerizing copolymers of styrene, diisobutene or isobutene or mixtures thereof with maleic anhydride in the absence of water and reacting the copolymers with alcohols after the polymerization, from 5 to 50 mol % of a monohydric alcohol being used per mole of anhydride groups in the copolymer. Suitable alcohols are, for example, methanol, ethanol, n-propanol, isopropanol, n-butanol, isobutanol and tert-butanol. However, the anhydride groups of the copolymers can also be reacted with monohydric alcohols, such as glycol or glycerol. However, in this case the reaction is continued only until only one OH group of the polyhydric alcohol reacts with the anhydride group. If the anhydride groups of the copolymers are not completely reacted with alcohols, ring opening of the anhydride groups not reacted with alcohols is effected by addition of water.

Other suitable dispersion stabilizers are mixtures of at least one surfactant and, for example, commercially available polymers of monoethylenically unsaturated acids and graft polymers of N-vinylformamide on polyalkylene glycols, which are described, for example, in WO 96/34903. The grafted-on vinylformamide units can, if appropriate, be hydrolyzed with formation of vinylamine units. The proportion of grafted-on vinylformamide units is preferably from 20 to 40% by weight, based on polyalkylene glycol. Polyethylene glycols having molar masses of from 2000 to 10 000 are preferably used.

Mixtures of at least one surfactant and zwitterionic polyalkylene polyamines and/or zwitterionic polyethyleneimines are also suitable as a dispersion stabilizer. Such compounds are disclosed, for example, in EP-B 0 112 592. They are obtainable, for example, by first alkoxylating a polyalkylaminepolyamine or polyethyleneimine, for example with ethylene oxide, propylene oxide and/or butylene oxide, and then quaternizing the alkoxylation products, for example with methyl bromide or dimethyl sulfate, and then sulfating the quaternized, alkoxylated products with chlorosulfonic acid or sulfur trioxide. The molar mass of the zwitterionic polyalkylene polyamine is, for example, from 1000 to 9000, preferably from 1500 to 7500. The zwitterionic polyethyleneimines preferably have molar masses in the range from 1500 to 7500 Dalton.

The component (a) of the paper size mixture is also advantageously obtainable by emulsifying a reactive size in the presence of a surfactant and at least one protective colloid which is selected, for example, from the group consisting of the polyvinyl alcohols, polyvinylpyrrolidones, polyacrylic acids, polyalkylene glycols, polyalkylene glycols endcapped at one or both ends with alkyl, carboxyl or amino groups, polydiallyidimethylammonium chlorides, water-soluble starches, water-soluble starch derivatives and/or water-soluble proteins. The protective colloids have as a rule average molar masses M_{w} above 500, preferably of more than 1000 to not more than 100 000, in general up to 60 000. In addition to said protective colloids for example, water-soluble cellulose derivatives, such as carboxymethylcellulose, and graft polymers of vinyl acetate and/or vinyl propionate on polyethylene glycols and/or polysaccharides are suitable. Water-soluble starches, starch derivatives and proteins are described, for example, in Römpp, Chemie Lexikon 9th edition, volume 5, page 3569, or in Houben-Weyl, Methoden der organischen Chemie, 4th edition, volume 14/2, chapter IV Umwandlung von Cellulose und Starke, by E. Husemann and R. Werner, pages 862-915, and in Ullmanns Encyclopedia of Industrial Chemistry, 6th edition, volume 28, page 533 et seq., under Polysaccharides.

Suitable protective colloids are in particular all types of water-soluble starch, for example both amylose and amylopectin, natural starches, hydrophobically or hydrophilically modified starches, anionic starches, cationically modified starches, maltodextrins, and degraded starches, it being possible for the starch degradation to be carried out, for example, oxidatively, thermally, hydrolytically or enzymatically and it being possible to use both natural and modified starches for the starch degradation. Further suitable protective colloids are dextrins and crosslinked water-soluble starches which are water-swellable.

Natural, water-soluble starches which can be converted into a water-soluble form, for example, with the aid of starch digestion and anionically modified starches, such as oxidized potato starch, are preferably used as the protective colloid. Anionically modified starches which were subjected to a decrease in molecular weight are particularly preferred. The molecular weight reduction is preferably carried out enzymatically. The average molar mass M_{w} of the degraded starches is, for example, from 500 to 100 000, preferably from 1000 to 30 000. The degraded starches have, for example, an intrinsic viscosity [η] of from 0.04 to 0.5 dl/g. Such starches are described, for example, in EP-B 0 257 412 and in EP-B 0 276 770. If protective colloids are used in the polymerization, the amounts used are, for example, from 0.5 to 50, in particular from 5 to 40, % by weight, in general from 10 to 30% by weight, based on the monomers used in the polymerization.

Particularly preferred dispersion stabilizers are combinations of at least one surfactant and of at least one degraded natural starch or at least one water-soluble cationic starch and mixtures of at least one surfactant and a dispersant comprising a condensate of naphthalenesulfonic acid and formaldehyde. The condensates of naphthalenesulfonic acid and formaldehyde can, if appropriate, also be modified by incorporation of urea in the form of condensed units. The condensates can be used in the form of the free acids and in partly or in completely neutralized form. Preferred neutralizing agents are sodium hydroxide solution, potassium hydroxide solution, ammonia, sodium bicarbonate, sodium carbonate or potassium carbonates. Ligninsulfonic acid or salts thereof are also suitable as dispersants. In addition to said neutralizing agents for naphthalenesulfonic acid, calcium hydroxide or calcium oxide is also suitable for the partial or complete neutralization of ligninsulfonic acid.

The component (a) of the mixtures according to the invention is preferably obtainable by emulsifying a reactive size in the presence of an anionic surfactant and at least one dispersant comprising a condensate of naphthalenesulfonic acid and formaldehyde and, if appropriate, at least one protective colloid.

The above-described aqueous dispersions of a reactive size are stable. For the preparation of the paper size mixtures according to the invention, they are mixed with at least one aqueous dispersion of an emulsion polymer of at least one ethylenically unsaturated monomer (component (b) of the mixtures according to the invention). The mixing of the dispersion can be carried out, for example, in a container in which, for example, the component (a) of the mixture (dispersion of a reactive size) is initially taken and the aqueous dispersion of an emulsion polymer (component (b)) is metered in with stirring. The component (b) can be added continuously, stepwise or all at once to the initially taken mixture. The mixtures according to the invention are also obtainable if the component (b) is initially taken in a container and the component (a) is metered continuously, stepwise or all at once into the initially taken mixture. It is also possible to combine the two components continuously with the aid of a binary nozzle or of a static mixer. The temperature may vary within a wide range during the mixing process. It is, for example, from 10 to 95° C., in general from 15 to 60° C. The mixing of the two components (a) and (b) is usually effected at the respective room temperature. An aqueous dispersion in which the dispersed constituents of the components (a) and (b) are present separately alongside one another is obtained. The weight ratio of the components (a) and (b) in the mixtures according to the invention is in particular from 5:1 to 1:5. Depending on the amount and type of the surfactants, dispersants and/or protective colloids used for stabilizing the dispersion of the reactive sizes, these dispersions have an anionic or cationic charge or are not charged. The pH of the aqueous dispersions of the reactive sizes is, for example, from 2 to 7, preferably from 3 to 5.

Aqueous dispersions of emulsion polymers of at least one ethylenically unsaturated monomer (component (b) of the mixtures according to the invention) are known. They are prepared by polymerization of the monomers in an aqueous medium in the presence of surface-active compounds and of free radical polymerization initiators. Suitable emulsion polymers are, for example, polymers which are composed of at least 40% by weight of so-called main monomers selected from C₁- to C₂₀-alkyl (meth)acrylates, vinyl esters of saturated carboxylic acids comprising up to 20 carbon atoms, vinylaromatics having up to 20 carbon atoms, ethylenically unsaturated nitriles, vinyl halides, vinyl ethers of alcohols comprising 1 to 10 carbon atoms, aliphatic hydrocarbons having 2 to 8 carbon atoms and one or two double bonds or mixtures of these monomers.

The emulsion polymers are preferably a polymer which comprises at least 70% by weight, particularly preferably at least 95% by weight, of so-called main monomers which are emulsifiable in water.

Examples of main monomers are neutral, monoethylenically unsaturated monomers from the group consisting of the vinylaromatic monomers, such as styrene, α-methylstyrene, tert-butylstyrene and vinyltoluene, esters of α,β-monoethylenically unsaturated mono- and dicarboxylic acids having 3 to 8 and in particular 3 or 4 carbon atoms with C₁-C₁₈-alkanols or with C₅-C₈-cycloalkanols, in particular the esters of acrylic acid, of methacrylic acid or of crotonic acid, the diesters of maleic acid, of fumaric acid and of itaconic acid and particularly preferably the esters of acrylic acid with C₁- to C₁₋₁₀-alkanols (═C₁- to —C₁₋₁₀-alkyl acrylates), such as ethyl acrylate, n-butyl acrylate, isobutyl acrylate, tert-butyl acrylate, n-hexyl acrylate, 2-ethylhexyl acrylate and 3-propylheptyl acrylate, and the esters of methacrylic acid with C₁- to C₁₋₁₀-alkanols, such as ethyl methacrylate, n-butyl methacrylate, isobutyl methacrylate, tert-butyl methacrylate, n-hexyl methacrylate and the like. Other suitable monomers of this type are vinyl and allyl esters of saturated aliphatic carboxylic acids having 1 to 18 carbon atoms, for example vinyl acetate, vinyl propionate and the vinyl esters of Versatic® acids (vinyl versatates), vinyl halides, such as vinyl chloride and vinylidene chloride, and C₂-C₆-olefins, such as ethylene, propene, 1-butene and n-hexene. Preferred monomers are vinylaromatic monomers, C₂-C₁₈-alkyl acrylates, in particular C₂-C₈-alkyl acrylates, especially tert-butyl acrylate, and C₂-C₁₈-alkyl methacrylates and in particular C₂-C₄-alkyl methacrylates.

In particular, at least 60% by weight of the main monomers which are used in the emulsion polymerization are selected from vinylaromatic monomers, in particular styrene, esters of methacrylic acid with C₂-C₄-alkanols and tert-butyl acrylate. Particularly preferred monomers of this type are vinylaromatic monomers, especially styrene, and mixtures of vinylaromatic monomers with the abovementioned C₂-C₈-alkyl acrylates and/or C₂-C₄-alkyl methacrylates.

The monomer composition may also comprise up to 20% by weight, based on the total weight of the monomers, of one or more monoethylenically unsaturated monomers (v) differing from the main monomers (iv). Preferably, the proportion of the monomers (v), based in the total amount of the monomers, accounts for 15% by weight, in particular up to 5% by weight. The monomers (v) are, however, used only in amounts such that the resulting polymers are insoluble in water so that dispersions are always obtained.

The monomers (v) include in particular monoethylenically unsaturated monomers which have at least one acid group, such as a sulfo group, a phosphonic acid group or one or two carboxyl groups and the salts of these monomers, in particular the alkali metal salts, e.g. the sodium or potassium salts, and the ammonium salts. This group of monomers (v) includes ethylenically unsaturated sulfonic acids, in particular vinylsulfonic acid, 2-acrylamido-2-methylpropanesulfonic acid, 2-acryloxyethane-sulfonic acid, 2-methacryloxyethane sulfonic acid, 3-acryloxy- and 3-methacryloxy-propanesulfonic acid, vinylbenzenesulfonic acid and salts thereof, ethylenically unsaturated phosphonic acids, such as vinylphosphonic acid, and dimethyl vinylphosphonate and salts thereof and α,β-ethylenically unsaturated C₃-C₈-mono- and C₄-C₈-dicarboxylic acids, in particular acrylic acid, methacrylic acid, crotonic acid, maleic acid, fumaric acid and itaconic acid. The proportion of monomers having acid groups will frequently account for not more than 20% by weight, preferably not more than 15% by weight, e.g. from 0.1 to 15% by weight, and in particular from 0.5 to 10% by weight, based on the total amount of the monomers.

The monomers of group (v) furthermore include monoethylenically unsaturated, neutral monomers, such as the amides of the abovementioned ethylenically unsaturated carboxylic acids, in particular acrylamide and methacrylamide, hydroxyalkyl esters of the abovementioned α,β-ethylenically unsaturated C₃-C₈-monocarboxylic acids and of the C₄-C₈-dicarboxylic acids, in particular 2-hydroxyethyl acrylate, 2-hydroxyethyl methacrylate, 2- and 3-hydroxypropyl acrylate, 2- and 3-hydroxypropyl methacrylate, esters of the abovementioned monoethylenically unsaturated mono- and dicarboxylic acids with C₂-C₄-polyalkylene glycols, in particular the esters of these carboxylic acids with polyethylene glycol or alkylpolyethylene glycols, the (alkyl)polyethylene glycol radical usually having a molecular weight in the range from 100 to 3000. The monomers (v) furthermore include N-vinylamides, such as N-vinylformamide, N-vinylpyrrolidone, N-vinylimidazole and N-vinylcaprolactam. The proportion of these monomers is likewise chosen so that the resulting polymers are insoluble in water. It is preferably not more than 20% by weight and in particular not more than 10% by weight, e.g. from 0.1 to 10 and in particular from 0.5 to 5% by weight, based on the total amount of the monomers

The monomers of group (v) furthermore include monoethylenically unsaturated monomers which have at least one cationic group and/or at least one amino group protonatable in an aqueous medium, a quaternary ammonium group, a protonatable imino group or a quaternized imino group. Examples of monomers having a protonable imino group are N-vinylimidazole and N-vinylpyridines. Examples of monomers having a quaternized imino group are N-alkylvinylpyridinium salts and N-alkyl-N′-vinylimidazolinium salts, such as N-methyl-N′-vinylimidazolinium chloride and methosulfate. Particularly preferred among these monomers are the monomers of the generally formula I

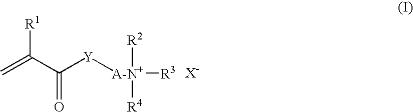

where
R¹ is hydrogen or C₁-C₄-alkyl, in particular hydrogen or methyl,
R², R³, independently of one another, are C₁-C₄-alkyl, in particular methyl, and
R⁴ is hydrogen or C₁-C₄-alkyl, in particular hydrogen or methyl,
Y is oxygen, NH or NR⁵, where R⁵ is C₁-C₄-alkyl,
A is C₂-C₈-alkylene, e.g. 1,2-ethanediyl, 1,2- or 1,3-propanediyl, 1,4-butanediyl or 2-methyl-1,2-propanediyl which, if appropriate, is interrupted by 1, 2 or 3 normeighboring oxygen atoms, and
X— is an anion equivalent, e.g. Cl—, HSO₄—, ½ SO₄²⁻ or CH₃OSO₃— etc.,
and, for Y═H, the free bases of the monomers of the formula I.

Examples of such monomers are 2-(N,N-dimethylamino)ethyl acrylate, 2-(N,N-dimethylamino)ethyl methacrylate, 2-(N,N-dimethylamino)ethylacrylamide, 3-(N,N-dimethylamino)propylacrylamide, 3-(N,N-dimethylamino)propylmethacrylamide, 2-(N,N-dimethylamino)ethylmethacrylamide, 2-(N,N,N-trimethylammonium)ethylacrylate chloride, 2-(N,N,N-trimethylammonium)ethylmethacrylate chloride, 2-(N,N,N-trimethylammonium)ethylmethacrylamide chloride, 3-(N,N,N-trimethylammonium)propylacrylamide chloride, 3-(N,N,N-trimethylammonium)propylmethacrylamide chloride, 2-(N,N,N-trimethylammonium)ethylacrylamide chloride and the corresponding metosulfates and sulfates.

The proportion of the cationic monomers in the emulsion polymer is advantageously from 0.1 to 20% by weight, in particular from 0.5 to 10% by weight and particularly preferably from 1 to 7% by weight, based on the total amount of the monomers.

The polymers can, if appropriate, comprise a further group of monomers (vi) incorporated in the form of polymerized units, which can usually be used as crosslinking agents in an emulsion polymerization. The proportion of monomers (vi), which have two or more ethylenically unsaturated double bonds, usually accounts, however, for not more than 10% by weight, in general not more than 5% by weight, in particular not more than 2% by weight, e.g. from 0.01 to 2% by weight and in particular from 0.05 to 1.5% by weight, based on the total amount of the monomers. Examples of crosslinking agents are butanediol diacrylate, butandiol dimethacrylate, hexanediol diacrylate, hexanediol dimethacrylate, glycol diacrylate, glycol dimethacrylate, trimethylolpropane triacrylate, trimethylolpropane trimethyacrylate, pentaerythrityl triacrylate, pentaerythrityl tetraacrylate, diacrylates and dimethacrylates of alkoxylated dihydric alcohols, divinylurea and/or conjugated diolefins, such as butadiene or isoprene.

Depending on the intended use, the monomers of group (vi) may also comprise so-called functional monomers, i.e. monomers which, in addition to a polymerizable C═C double bond also have a reactive functional group, for example an oxirane group, a reactive carbonyl group, e.g. an acetoacetal group, an isocyanate group, a N-hydroxymethyl group, a N-alkoxymethyl group, a trialkylsilyl group, a trialkoxysilyl group or another group reactive toward nucleophiles.

Also of interest are those emulsion polymers whose monomer composition is chosen so that the resulting polymer has a glass transition temperature of at least 0° C., preferably at least 10° C., in particular in the range from 20 to 130° C.

In order to prepare polymers having such a glass transition temperature, for example, the monomers (i) in the monomer mixture are selected so that they correspond to a polymer 1 having a theoretical glass transition temperature according to Fox, T_{g}(Fox), of at least 50° C. According to Fox (T. G. Fox, Bull. Am. Phys. Soc. (Ser. II) 1, 123 [1956] and Ullmanns Enzyklopädie dertechnischen Chemie, Weinheim (1980), pages 17-18), a good approximation for the glass transition temperature of uncrosslinked or weakly crosslinked copolymers in the case of large molar masses is

$$\frac{1}{{T}_{g}} = \frac{{X}^{1}}{{T}_{g}^{1}} + \frac{{X}^{2}}{{T}_{g}^{2}} + … \frac{{X}^{n}}{{T}_{g}^{n}}$$

where X¹, X², . . . , Xⁿ are the mass fractions of the monomers 1, 2, . . . , n and T_{g}¹, T_{g}², . . . , T_{g}ⁿ by the glass transition temperature of the polymers composed in each case only of one of the monomers 1, 2, . . . , n, in degrees Kelvin. The latter are known, for example, from Ullmann's Encyclopedia of Industrial Chemistry, VCH, Weinheim, Vol. A 21 (1992), page 169, or from J. Brandrup, E. H. Immergut, Polymer Handbook 3rd ed., J. Wiley, New York 1989.

The polymerization of the monomers is effected by an emulsion polymerization method, i.e. the monomers to be polymerized are present in the polymerization mixture as an aqueous emulsion. For stabilizing the monomer emulsions, the compounds used are the same as those which are used as a dispersion stabilizer for the preparation of the aqueous dispersions of reactive sizes, e.g. surfactants, in particular anionic surfactants, water-soluble starch, preferably anionic starch, and protective colloids.

The monomer can be initially taken in the reactor before the beginning of the polymerization or can be added under polymerization conditions in one or more portions or continuously to the polymerizing reaction mixture. For example, the main amount of the monomers, in particular at least 80% and particularly preferably the total amount, can be initially taken in the polymerization vessel and the polymerization started directly thereafter by adding a polymerization initiator. The further process variant consists in first initially taking a part (e.g. from 5 to 25%) of the monomers or of the monomer emulsion in the polymerization reactor, starting the polymerization by adding an initiator and adding the remaining amount of monomers or monomer emulsion to the reactor continuously or in portions and continuing the polymerization of the monomers to completion. In this process variant, the polymerization initiator can, for example, be partly or completely initially taken in the reactor or metered into the reactor separately from the remaining monomers.

The initiators suitable for the emulsion polymerization are in principle all polymerization initiators which are suitable for emulsion polymerization and are usually used and which initiate a radical polymerization of ethylenically unsaturated monomers. These include, for example, azo compounds, such as 2,2′-azobisisobutyronitrile, 2,2′-azobis(2-methylbutyronitrile), 2,2′-azobis[2-methyl-N-(2-hydroxyethyl)propion-amide, 1,1′-azobis(1-cyclohexanecarbonitrile), 2,2′-azobis(2,4-dimethylvaleronitrile), 2,2′-azobis(N,N′-dimethyleneisobutyramidine) dihydrochloride and 2,2′-azobis(2-amidinopropane) dihydrochloride, organic or inorganic peroxides, such as diacetyl peroxide, di-tert-butyl peroxide, diamyl peroxide, dioctanoyl peroxide, didecanoyl peroxide, dilauroyl peroxide, dibenzoyl peroxide, bis(o-toluoyl) peroxide, succinyl peroxide, tert-butyl peracetate, tert-butyl permaleate, tert-butyl perisobutyrate, tert-butyl perpivalate, tert-butyl peroctanoate, tert-butyl perneodecanoate, tert-butyl perbenzoate, tert-butyl peroxide, tert-butyl hydroperoxide, cumyl hydroperoxide, tert-butyl peroxy-2-ethylhexanoate and diisopropyl peroxydicarbamate, salts of peroxodisulfuric acid and redox initiator systems.

A redox initiator system is preferably used for the polymerization, in particular a redox initiator system which comprises a salt of peroxodisulfuric acid, hydrogen peroxide or an organic peroxide, such as tert-butyl hydroperoxide, as the oxidizing agent. The redox initiator systems preferably comprise, as the reducing agent, a sulfur compound which is selected in particular from sodium hydrogen sulfite, sodium hydroxymethanesulfinate and a hydrogen sulfite adduct with acetone. Further suitable reducing agents are phosphorus-containing compounds, such as phosphorous acid, hypophosphite and phosphinates, and hydrazine or hydrazine hydrate and ascorbic acid. Furthermore, redox initiator systems may comprise small added amounts of redox metal salts, such as iron salts, vanadium salts, copper salts, chromium salts or manganese salts, such as, for example, the redox initiator system ascorbic acid/iron(II) sulfate/sodium peroxodisulfate. Particularly preferred redox initiator systems are acetone bisulfite adduct/organic hydroperoxide, such as tert-butyl hydroperoxide; sodium disulfite (Na₂S₂O₅)/organic hydroperoxide, such as tert-butyl hydroperoxide; sodium hydroxymethanesulfinate/organic hydroperoxide, such as tert-butyl hydroperoxide; and ascorbic acid/hydrogen peroxide.

Usually, the initiator is used in an amount of from 0.02 to 2% by weight and in particular from 0.05 to 1.5% by weight, based on the amount of the monomers. Of course, the optimum amount of initiator depends on the initiator system used and can be determined by the person skilled in the art in routine experiments. The initiator can be initially taken partly or completely in the reaction vessel. In general, a portion of the amount of initiator is initially taken together with a portion of the monomer emulsion, and the remaining initiator is added continuously or batchwise together with the monomers, but separately therefrom.

Pressure and temperature are of minor importance for carrying out the polymerization of the monomers. Of course, the temperature depends on the initiator system used. The optimum polymerization temperature can be determined by the person skilled in the art with the aid of routine experiments. Usually, the polymerization temperature is in the range from 0 to 110° C., frequently in the range from 30 to 95° C. The polymerization is usually carried out at atmospheric pressure or ambient pressure. However, it can also be carried out at superatmospheric pressure, e.g. up to 10 bar, or at reduced pressure, e.g. from 20 to 900 mbar, but in general at >800 mbar. Polymerization is preferably effected under the so-called “starved conditions”, i.e. conditions which as far as possible permit little or no formation of empty micelles and hence the formation of polymer particles free of active substance. For this purpose, either no further surface-active substance is added or only so little further substance-active substance that the water-insoluble monomer droplets are stabilized in the aqueous phase. This ensures that no measurable proportions of stabilized droplets of monomers are present in the reaction mixture in which a polymerization can take place, and the surface-active substances present in the polymerization mixture serves substantially for wetting the surfaces and for transporting the monomers (iv) through the continuous aqueous phase.

If, in the emulsion polymerization, a dispersion stabilizer was also added for stabilizing the resulting emulsion polymers, preferably at least one further surface-active substance is metered in an amount of, for example, up to 5% by weight, e.g. from 0.1 to 5% by weight, based on the monomers to be polymerized. In addition to the nonionic surface-active substances, in particular anionic emulsifiers, e.g. alkylsulfates, alkanesulfonates, alkylarylsulfonates, alkyl ether sulfates, alkylaryl ether sulfates, anionic starch, sulfosuccinates, such as sulfosuccinic monoesters and sulfosuccinic diesters, and alkyl ether phosphates, and furthermore cationic emulsifiers are suitable as further surface-active substances. These compounds are used as surfactants in the preparation of component (a) of the mixtures according to the invention.

In a preferred embodiment of the invention, the emulsion polymerization of the monomers is carried out in the presence of, for example, up to 20% by weight, in general up to 10% by weight, based on the total dispersion, of a cationically or anionically modified starch.

Of course, further additives which are customary in emulsion polymerization, for example glycols, polyethylene glycols, buffer/pH regulators, molecular weight regulators and chain transfer inhibitors, can be added to the reaction mixture which is to be polymerized.

In order to modify the properties of the polymers, the emulsion polymerization can be carried out, if appropriate, in the presence of at least one polymerization regulator. Examples of polymerization regulators are organic compounds which comprise sulfur in bound form, such as dodecyl mercaptan, thiodiglycol, ethylthioethanol, di-n-butyl sulfide, di-n-octyl sulfide, diphenyl sulfide, diisopropyl disulfide, 2-mercaptoethanol, 1,3-mercaptopropanol, 3-mercaptopropane-1,2-diol, 1,4-mercaptobutanol, thioglycolic acid, 3-mercaptopropionic acid, mercaptosuccinic acid, thioacetic acid and thiourea, aldehydes, such as formaldehyde, acetaldehyde and propionaldehyde, organic acids, such as formic acid, sodium formate or ammonium formate, alcohols, such as, in particular, isopropanol, and phosphorus compounds, such as sodium hypophosphite. If a regulator is used in the polymerization, the amount used in each case is, for example, from 0.01 to 5, preferably from 0.1 to 1, % by weight, based on the monomers used in the polymerization. Polymerization regulator and crosslinking agent can be used together in the polymerization. Thus, for example, the rheology of the resulting polymer dispersions can be controlled.

The polymerization is carried out as a rule at a pH of from 2 to 9, preferably in the weakly acidic range at a pH of from 3 to 5.5. The pH can be adjusted to the desired value before or during the polymerization with customary acids, such as hydrochloric acid, sulfuric acid or acetic acid, or bases, such as sodium hydroxide solution, potassium hydroxide solution, ammonia, ammonium carbonate, etc. The dispersion is preferably adjusted to a pH of from 5 to 7 up to the end of the polymerization with sodium hydroxide solution, potassium hydroxide solution or ammonia.

In order to remove the residual monomers as substantially as possible from the polymer dispersion, postpolymerization is expediently carried out after the end of the actual polymerization. For this purpose, for example, an initiator from the group consisting of hydrogen peroxide, peroxides, hydroperoxides and/or azo initiators is added to the polymer dispersion after the end of the main polymerization. The combination of the initiators with suitable reducing agents, such as, for example, ascorbic acid or sodium bisulfite, is also possible. Oil-soluble initiators which are sparingly soluble in water are preferably used, for example customary organic peroxides, such as dibenzoyl peroxide, di-tert-butyl peroxide, tert-butyl hydroperoxide, cumyl hydroperoxide or biscyclohexyl peroxydicarbonate. For the postpolymerization, the reaction mixture is heated, for example, to a temperature which corresponds to the temperature at which the main polymerization is carried out or which is up to 20° C., preferably up to 10° C., higher. The main polymerization is complete when the polymerization initiator has been consumed or the monomer conversion is, for example, at least 98%, preferably at least 99.5%. For the postpolymerization, tert-butyl hydroperoxide is preferably used. The polymerization is carried out, for example, in a temperature range from 40 to 100° C., in general from 50 to 95° C.

After the end of the polymerization, the complexing agent for heavy metal ions can be added to the polymer dispersion in an amount such that all heavy metal ions are complexed. The starch-containing polymer dispersions comprise dispersed particles having a mean particle size of, for example, from 20 to 500 nm, preferably from 50 to 250 nm. The mean particle size can be determined by methods known to the person skilled in the art, such as, for example, laser correlation spectroscopy, ultracentrifuging or CHDF (capillary hydrodynamic fractionation). A further measure of the particle size of the dispersed polymer particle is the LT value (value for the light transmittance). For determining the LT value, the polymer dispersion to be investigated in each case is measured in 0.1% strength by weight aqueous dilution in a cell having an edge length of 2.5 cm using the light of 600 nm wavelength and is compared with the corresponding transmittance of water under the same measuring conditions. The transmittance of water is specified as 100%. The more finely divided the dispersion, the higher is the LT value which is measured by the method described above. The mean particle size can be calculated from the measured values, cf. B. Verner, M. Barta, B. Sedlacek, Tables of Scattering Functions for Spherical Particles, Prague, 1976, Edice Marco, Rada D-DATA, SVAZEK D-1.

The solids content of the starch-containing polymer dispersion is, for example, from 5 to 50% by weight and is preferably in the range from 15 to 40% by weight.

For example, the paper size mixtures according to the invention comprise, as component (b), an emulsion polymer of
(iv) at least one alkyl acrylate, alkyl methacrylate, vinyl ester of saturated carboxylic acids having 1 to 20 carbon atoms, vinylaromatic having up to 20 carbon atoms, ethylenically unsaturated nitrile, vinyl halogenide, vinyl ether of alcohols comprising 1 to 10 carbon atoms, aliphatic hydrocarbon having 2 to 8 carbon atoms and one or two double bonds and
(v) if appropriate, at least one cationic and/or at least one anionic monomer.

In a preferred embodiment, the component (b) consists of an emulsion polymer of
(iv) an alkyl acrylate, alkyl methacrylate, styrene, acrylonitrile, methacrylonitrile and mixtures thereof and
(v) a dialkylaminoalkyl acrylate, dialkylaminoalkyl methacrylate, diallyldimethylammonium chloride, dialkylaminoalkylacrylamide, dialkylaminoalkylmethacrylamide, acrylic acid, methacrylic acid, itaconic acid, maleic acid, fumaric acid, crotonic acid and mixtures thereof.

In a particularly preferred embodiment, an aqueous dispersion of an emulsion polymer which is obtainable by polymerization of ethylenically unsaturated monomers in the presence of a degraded starch is used as component (b). Such emulsion polymers are likewise known. They are used, for example, as size for paper, cf. JP-A 58/115 196, EP-B 0 257 412, EP-B 0 267 770, EP-A 0 307 812, EP-A 0 536 597, EP-A 1 056 783, WO 00/23479, WO 02/14393, EP-B 1 165 642 and WO 2004/078807.

Of particular industrial interest are emulsion polymers which are obtainable by polymerization of
(iv) acrylonitrile, methacrylonitrile, styrene and/or C₄- to C₂₄-olefins and
(v) ethyl acrylate, n-butyl acrylate, tert-butyl acrylate, hexyl acrylate and/or ethylhexyl acrylate and, if appropriate,
(vi) further monomers

in an aqueous solution or degraded starch. All natural starches, such as potato starch, corn starch, wheat starch, rice starch, starches having an amylopectin content of more than 95% and tapioca starch, and cationically and anionically modified starches are suitable as starch. The starches are subjected to a molecular weight reduction before the polymerization is carried out in the solution of a degraded starch. The degradation of the starch can be carried out oxidatively, hydrolytically or enzymatically. The starch is preferably degraded enzymatically. The molar masses M_{w} of the degraded starches are, for example, in the range from 1000 to 100 000, preferably from 1000 to 60 000. The polymer dispersions may comprise, for example, up to 20% by weight of at least one degraded starch. In general, the content of degraded starch in the emulsion polymers used as component (b) is from 5 to 15% by weight.

Aqueous dispersions which are obtainable by free radical polymerization of monomers of the abovementioned groups (iv) and (v) in the presence of low molecular weight prepolymers as an emulsifier are also suitable as component (b). Such prepolymers are disclosed, for example, in EP-A 0 051 144. They are prepared by a two-stage polymerization, in which, in the first polymerization stage, a monomer mixture which comprises from 2.5 to 10 mol of at least one nonionic, hydrophobic, ethylenically unsaturated monomer, from 0.5 to 1.5 mol of an ethylenically unsaturated carboxylic acid and, if appropriate, up to 9 mol of a nonionic hydrophilic, ethylenically unsaturated monomer per mole of a nitrogen-containing monomer which carries an amino and/or quaternary ammonium group is polymerized in a water-miscible solvent by a solution copolymerization method, the solution of the prepolymer is then diluted with water and ethylenically unsaturated monomers are polymerized therein by an emulsion polymerization method. Suitable solvents for the preparation of the prepolymers are, for example, carboxylic acids, such as formic acid, acetic acid and propionic acid, alcohols, such as methanol, ethanol, n-propanol or isopropanol, and ketones, such as acetone or methyl ethyl ketone, and dimethylformamide. In order to prepare, for example, an emulsion polymer suitable as component (b) of the paper size mixtures, the monomers (iv) and (v) and, if appropriate, (vi) described above can be polymerized by an emulsion polymerization method in an aqueous solution of such a prepolymer.

The paper size mixtures according to the invention may comprise, as component (b), for example, an aqueous dispersion of an emulsion polymer which is obtainable by free radical polymerization of
(iv) at least one alkyl acrylate, alkyl methacrylate, vinyl ester of saturated carboxylic acids having 1 to 20 carbon atoms, vinylaromatic having up to 20 carbon atoms, ethylenically unsaturated nitrile, vinyl halide, vinyl ether of alcohols comprising 1 to 10 carbon atoms, aliphatic hydrocarbon having 2 to 8 carbon atoms and one or two double bonds and
(v) if appropriate, at least one cationic and/or at least one anionic monomer
   in the presence of at least one low molecular weight prepolymer as an emulsifier.

A further example of polymer which is suitable as component (b) of the mixture according to the invention comprises emulsion polymers which are obtainable by free radical polymerization of
(iv) from 30 to 60% by weight of at least one optionally substituted styrene, acrylonitrile and/or methacrylonitrile,
(v) from 5 to 50% by weight of at least one C₁-C₁₂-alkyl acrylate and/or one C₁-C₁₂-alkyl methacrylate,
(vi) from 5 to 30% by weight of at least one C₄- to C₂₄-olefin,
(vii) from 0 to 10% by weight of at least one other ethylenically unsaturated copolymerizable monomer, and
(viii) from 15 to 35% by weight of a degraded starch,
   the sum here is (iv)+(v)+(vi)+(vii)+(viii)=100% being based on the total solids content. For the preparation of these polymer dispersions, isobutene, diisobutene, 1-octene, 1-decene, 1-dodecene and mixtures of such olefin are preferably used as olefins.

The paper size mixture can moreover comprise, as component (b), at least one water-soluble or water-dispersible polymer which does not have a dispersing effect and is selected from the group consisting of polymers comprising ethyleneimine units, water-soluble polyurethanes, water-soluble polyesters, water-soluble ethylene copolymers with anionic and/or cationic monomers or mixtures thereof. The molar masses M_{w} of these polymers are, for example, at least 5000, preferably at least 100 000. They are in general in the range from 50 000 to 500 000.

Polymers containing ethyleneimine units are known. They are prepared, for example, by polymerization of ethyleneimine in an aqueous medium in the presence of, for example, acids, halogenated hydrocarbons or Lewis acids as a catalyst. They are also obtainable by grafting ethyleneimine onto basic compounds comprising nitrogen atoms, e.g. by grafting condensates of a polyamidoamine and a dicarboxylic acid with ethyleneimine, cf. DE-B 24 34 816. A commercially available product of this type is Polymin® SK from BASF, Ludwigshafen.

Polymers comprising vinylamine units are obtainable by hydrolysis of polymers comprising vinyl formamide units. Polyvinylamines are prepared, for example, by hydrolysis of homopolymers of N-vinylformamide, the degree of hydrolysis being, for example, up to 100%, in general from 70 to 95%. High molecular weight copolymers of N-vinylformamide with other ethylenically unsaturated monomers, such as vinyl acetate, vinyl propionate, methyl acrylate, methyl methacrylate, acrylamide, acrylonitrile and/or methacrylonitrile, can also be hydrolyzed to give polymers comprising vinylidene units and are used according to the invention as component (b). The polymers comprising vinylamine units are cationic. In the hydrolysis of polymers of N-vinylformamide with acids, the salts of the polymers (ammonium salts) form, whereas in the hydrolysis with bases, such as sodium hydroxide solution or potassium hydroxide solution, polymers carrying amino groups form. The preparation of homo- and copolymers of N-vinylformamide and the preparation of the polymers obtainable therefrom by hydrolysis and having amino or ammonium groups are known. It is described, for example, in U.S. Pat. No. 6,132,558, column 2, line 36 to column 5, line 25. The statements made there are hereby incorporated by reference.

Modified polyamines which do not have a dispersing effect and which are grafted with ethyleneimine and, if appropriate, crosslinked, polyetheramides, polyvinylimidazoles, polyvinylpyrrolidines, polyvinylimidazolines, polyvinyltetrahydropyrines, poly(dialkylaminoalkyl vinyl ethers) and poly(dialkylaminoalkyl (meth)acrylates) in protonated or in quaternary form are also suitable in each case as component (b) of the mixture according to the invention.

The above-described finely divided, aqueous mixtures of (a) a dispersion of a reactive size and (b) an emulsion polymer and/or a water-soluble polymer which doesn't have a dispersing effect are used as sizes for paper and paper products, such as board and cardboard. They can be used both as surface sizes and as engine sizes in the amounts customary in each case. The use as surface sizes is preferred. The mixtures, according to the invention, of the dispersions of the components (a) and (b) can be processed by all methods suitable in the case of surface sizing. For use, the dispersion is usually added to the size press liquor in an amount of from 0.05 to 5% by weight, based on solid substance, and depending on the desired degree of sizing of the papers or paper products to be finished. Furthermore, the size press liquor may comprise further substances, such as, for example, starch, pigments, optical brighteners, biocides, strength agents for paper, fixing agents, antifoams, retention aids and/or drainage aids. The size dispersion can be applied to paper, board or cardboard by means of a size press or other application units, such as film press, speedsizer or gate-roll. The amount of polymer which is applied in this manner to the surface of paper products is, for example, from 0.005 to 1.0 g/m², preferably from 0.01 to 0.5 g/m².

The paper size mixtures according to the invention can be used for the production of all paper types, e.g. of writing and printing papers and packaging papers, in particular of papers for the packaging of liquids.

Paper products which are sized with the finely divided, starch-containing polymer dispersions according to the invention have an improved degree of sizing, good immediate sizing, improved inkjet printability and good polymer adhesion compared with papers which are sized using known sizes.

Unless evident otherwise from the context, the stated percentages in the examples are always percentages by weight and the parts are parts by weight. The particle sizes were determined by means of a high performance particle sizer (HPPS) from Malvern using an He—Ne laser (633 nm) at a scattering angle of 173°.

### EXAMPLES

### Preparation of Aqueous Alkyl Ketene Dimer Dispersions

### AKD Dispersion A

120 g of stearyl diketene, 871.3 g of demineralized water, 12 g of sodium dodecyl-sulfonate and 7.6 g of a condensate of naphthalenesulfonic acid and formaldehyde (Tamol® NNP) were mixed and heated to a temperature of 85° C. As soon as this temperature was reached, the mixture was preemulsified with the aid of UltraTurrax® apparatus at 6000 rpm in the course of 5 minutes and then emulsified three times at 80° C. using a homogenizer (AVP Gaulin LAB 40, 600 bar) and rapidly cooled to room temperature. The finely divided aqueous dispersion of stearyl diketene having a mean particle size distribution of 144 nm was obtained.

### AKD Dispersion B

120 g of stearyl diketene, 871.3 g of demineralized water, 8.2 g of a C₁₃-oxo alcohol having a degree of ethoxylation of 10 and 7.6 g of a condensate of naphthalenesulfonic acid and formaldehyde (Tamol® NNP) were mixed and were heated to a temperature of 85° C. At this temperature, the mixture was preemulsified using an UltraTurrax® at 6000 rpm for 5 minutes. Thereafter, the mixture was emulsified three times at 80° C. using a homogenizer (APV Gaulin LAB 40, 600 bar) and the emulsion was rapidly cooled to room temperature. A finely divided aqueous dispersion of stearyl diketene having a mean particle size distribution of 167 nm was obtained.

### AKD Dispersion C

120 g of stearyl diketene, 871.3 g of demineralized water, 10.4 g of an oleylamine ethoxylate (Lipamin® OK) and 34.5 g of a maltodextrin starch (average molar mass M_{w} about 10 000 da) were mixed and were heated to a temperature of 85° C. After this temperature was reached, the mixture was preemulsified using UltraTurrax® at 6000 rpm for 5 minutes then emulsified three times at a temperature of 80° C. using a homogenizer (APV Gaulin LAB 40, 600 bar) and rapidly cooled to room temperature. The finely divided aqueous dispersion of stearyl diketene having a mean particle size of 185 nm was obtained.

### Examples 1-6

The AKD dispersions A-C described above were mixed with the polymers stated in each case in the following examples in a 1.5 l stirred vessel equipped with a stirrer at a stirrer speed of 250 rpm and a temperature of 25° C., the polymers being metered in the course of 15 minutes into the AKD dispersion initially taken in the flask. The mixtures were then tested as surface sizes and engine sizes for paper.

### Example 1

Mixing of 30 parts of AKD dispersion A with 70 parts of a 24.9% strength aqueous dispersion of a copolymer of styrene and butyl acrylate, prepared in the presence of an anionic starch (Basoplast® 400 DS).

### Example 2

Mixing of 30 parts of AKD dispersion A with 70 parts of a 35.4% strength aqueous dispersion of a copolymer of styrene and butyl acrylate, prepared in the presence of anionic starch (Basoplast® PR 8152).

### Example 3

Mixing of 30 parts of AKD dispersion C with 70 parts of a 30.3% strength aqueous dispersion of a copolymer which is obtainable in an aqueous solution of a cationic prepolymer by polymerization of styrene and butyl acrylate (Basoplast® 270 D).

### Example 4

Mixing of 40 parts of AKD dispersion B with 60 parts of a 20% strength aqueous solution of a polyvinylformamide having a degree of hydrolysis of 10% (copolymer comprising 90 mol % of vinylformamide units and 10 mol % of vinylamine units) (Lupamin® 9010).

### Example 5

Mixing of 30 parts of AKD dispersion C with 70 parts of a 34.8% strength aqueous dispersion of a copolymer of acrylonitrile and butyl acrylate, prepared in the presence of cationic starch (Basoplast® PR 250).

### Example 6

Mixing of 30 parts of AKD dispersion A with 70 parts of a 30.1% strength aqueous dispersion of a copolymer of acrylonitrile and butyl acrylate, prepared in the presence of anionic starch (Basoplast® PR 335).

### Test Methods

The degree of sizing was determined according to Cobb60 according to DIN EN 20 535. The HST value was determined by the Hercules Sizing Test according to Tappi standard T 530. The ink flotation test was carried out according to DIN 53 126 using a blue paper test ink. The toner adhesion was carried out using an IGT tester according to the EN 12 283 method.

### Testing of Performance Characteristics:

1) Testing of performance characteristics as surface size for wood-free papers

An anionically modified potato starch was brought into solution with heating to 95° C. for 30 minutes. Thereafter, the polymer dispersion to be tested was added to the starch solution and dilution with water was effected so that a starch concentration of 8% was present in the final mixture. The mixture of starch solution and polymer dispersion was then applied by means of a size press to a wood-free, unsized paper having a grammage of 80 g/m² at a temperature of 55° C. The take-up of the preparation was in the range of 50-60%. Thereafter, the paper is thus treated with drying by means of contact drying at 90° C., conditioned for 24 h at 50% relative humidity and then subjected to the abovementioned test.

For comparison with the prior art, the following compositions are tested:

Comparative example 1

Commercially available aqueous size dispersion (Basoplast® 400DS) based on a styrene/butyl acrylate polymer. The solids content of the dispersion was 24.9% and the particle size distribution 101 nm.

Comparative example 2

Commercially available stearyl diketene dispersion, mean particle size of the dispersed stearyl diketene 980 nm

Comparative example 3: AKD dispersion A
Comparative example 4: AKD dispersion B
Comparative example 5: AKD dispersion C

The results obtained in the tests for the surface sizing are shown in table 1.

TABLE 1

| | Cobb | | | | |
|---|---|---|---|---|---|
| Size mixture or | 60 [g/m²] | | HST [sec] | | Toner adhesion |
| size according to | 1 g/l | 2 g/l | 1 g/l | 2 g/l | [% ink density] |
| Example 1 | 39 | 23 | 67 | 242 | 74 |
| Example 2 | 42 | 26 | 38 | 199 | 84 |
| Example 3 | 33 | 22 | 109 | 258 | 88 |
| Example 4 | 41 | 27 | 62 | 176 | 93 |
| Example 5 | 45 | 29 | 58 | 199 | 77 |
| Example 6 | 48 | 32 | 44 | 174 | 72 |
| Comparative example 1 | 51 | 35 | 43 | 119 | 89 |
| Comparative example 2 | 36 | 25 | 124 | 267 | 45 |
| Comparative example 3 | 33 | 23 | 145 | 301 | 56 |
| Comparative example 4 | 32 | 21 | 135 | 287 | 51 |
| Comparative example 5 | 32 | 21 | 167 | 321 | 62 |

### 2) Testing of Performance Characteristics as Surface Size for Test Liner

A natural corn starch was brought into solution with heating to 95° C. for 30 minutes and degraded to a viscosity of about 30 mPa·s (Brookfield, spindle 1, 50° C.) by adding alpha-amylase. In each case the dispersions to be tested (i.e. size from examples 1-6 or comparative examples 1-5) were added to the starch solution and dilution was effected with water so that a starch concentration of 8% was present in the final mixture. The mixture of starch solution and size dispersion was then applied by means of a size press to a test liner (100% wastepaper, 100 g/m²) at a temperature of 55° C. The take-up of the preparation was in the region of about 65%. Thereafter, the papers thus treated were dried by means of contact drying at 90° C., conditioned for 24 h at 50% relative humidity and then subjected to the abovementioned tests. The results are shown in table 2 (concentration of size in the mixture 1 g/l).

TABLE 2

| | Cobb 60 | Cobb 120 |
|---|---|---|
| Size mixture or size according to | [g/m²] | [g/m²] |
| Example 1 | 31 | 56 |
| Example 2 | 35 | 63 |
| Example 3 | 25 | 44 |
| Example 4 | 28 | 42 |
| Example 5 | 33 | 59 |
| Example 6 | 38 | 74 |
| Comparative example 1 | 54 | 98 |
| Comparative example 2 | 35 | 84 |
| Comparative example 3 | 45 | 86 |
| Comparative example 4 | 48 | 91 |
| Comparative example 5 | 42 | 73 |

### 3) Testing of Performance Characteristics as Engine Size

In each case 1.2 kg/t, always based on solids content, of size mixture (examples 1-6) or size (comparative examples 1-5) and 20% of calcium carbonate, 0.6% of a cationic corn starch and 0.04% of a cationic polyacrylamide (Polymine KE215) as a retention aid, based in each case on dry fiber mixture, were added to a paper stock having a consistency of 8 g/l and comprising a completely bleached mixture of 70% of pine and 30% of birch sulfate pulp having a freeness of 35° SR (Schopper-Riegler). The pH of the paper slurry was adjusted to 7. The paper stocks were processed in each case on a Rapid-Kö then sheet former to give a sheet having a basis weight of 80 g/m². Thereafter, the sheets were dried on a steam-heated drying cylinder at a temperature of 90° C. to a water content of 5% and then stored for 24 hours at 25° C. under relative humidity at 50%, and the values for Cobb 60 and the ink flotation time were then determined. The measured values are shown in table 3.

TABLE 3

| | Cobb 60 | Ink flotation time |
|---|---|---|
| Size mixture or size according to | [g/m²] | [min] |
| Example 1 | 55 | 22 |
| Example 2 | 62 | 6 |
| Example 3 | 41 | 32 |
| Example 4 | 33 | 45 |
| Example 5 | 52 | 17 |
| Example 6 | 74 | 9 |
| Comparative example 1 | 89 | 2 |
| Comparative example 2 | 35 | 22 |
| Comparative example 3 | 38 | 24 |
| Comparative example 4 | 37 | 21 |
| Comparative example 5 | 33 | 39 |

1. A paper size mixture comprising a reactive size dispersed in water and a polymer, wherein said mixture is produced by mixing
(a) an aqueous dispersion of a reactive size whose dispersed particles have a mean particle diameter of less than 500 nm, the dispersion being prepared by emulsifying at least one reactive size in water in the presence of at least one surfactant, and
(b) at least one emulsion polymer and/or at least one water-soluble polymer which does not have a dispersing effect with respect to reactive sizes and/or a water-dispersible polymer.

2. The paper size mixture according to claim 1, wherein component (a) of the mixture is an aqueous dispersion of a reactive size whose dispersed particles have a mean particle diameter of not more than 300 nm.

3. The paper size mixture according to claim 1, wherein component (a) of the mixture comprises, as the reactive size, an aqueous dispersion of at least one of an alkylketene dimer and an alkenylsuccinic anhydride having a mean particle size of the dispersed particles of from 30 to 300 nm.

4. The paper size mixture according to claim 1, wherein the weight ratio of components (a) and (b) in the mixture is from 1:100 to 100:1.

5. The paper size mixture according to claim 1, wherein the weight ratio of components (a) and (b) in the mixture is from 1:20 to 20:1.

6. The paper size mixture according to claim 1, which comprises as components
(a) an aqueous dispersion of an alkylketene dimer which is emulsified with the aid of a cationic, anionic and/or nonionic surfactant, and comprises as a component
(b) at least one emulsion polymer having a mean particle diameter of not more than 1000 nm.

7. The paper size mixture according to claim 1, wherein component (a) of the mixture is prepared by emulsifying a reactive size in the presence of a surfactant and at least one dispersant and/or at least one protective colloid.

8. The paper size mixture according to claim 1, wherein component (a) of the mixture is prepared by emulsifying a reactive size in the presence of a surfactant and at least one protective colloid from the group consisting of the polyvinyl alcohols, polyvinylpyrrolidones, polyacrylic acids, polyalkylene glycols, polyalkylene glycols endcapped at one or both ends with alkyl, carboxyl or amino groups, polydiallyldimethylammonium chlorides, water-soluble starches, water-soluble starch derivatives, water-soluble proteins and mixtures thereof.

9. The paper size mixture according to claim 1, wherein component (a) of the mixture is prepared by emulsifying a reactive size in the presence of a surfactant and at least one dispersant from the group consisting of the condensates of naphthalenesulfonic acid and/or the salts thereof and formaldehyde, ligninsulfonic acid and/or the salts thereof, amphiphilic polymers and/or nanoparticles of organic polymers or of inorganic compounds.

10. The paper size mixture according to claim 1, wherein component (a) of the mixture is prepared by emulsifying a reactive size in the presence of an anionic surfactant and at least one dispersant comprising a condensate of naphthalenesulfonic acid and formaldehyde and, optionally, at least one protective colloid.

11. The paper size mixture according to claim 1, which comprises, as component (b), an aqueous dispersion of an emulsion polymer of at least one ethylenically unsaturated monomer.

12. The paper size mixture according to claim 1, which comprises, as component (b), an emulsion polymer of
(iv) at least one alkyl acrylate, alkyl methacrylate, vinyl ester of saturated carboxylic acids having 1 to 20 carbon atoms, vinylaromatic having up to 20 carbon atoms, ethylenically unsaturated nitrile, vinyl halogenide, vinyl ether of alcohols comprising 1 to 10 carbon atoms, aliphatic hydrocarbon having 2 to 8 carbon atoms and one or two double bonds and
(v) optionally, at least one cationic and/or at least one anionic monomer.

13. The paper size mixture according to claim 1, which comprises, as component (b), an emulsion polymer of
(iv) an alkyl acrylate, alkyl methacrylate, styrene, acrylonitrile, methacrylonitrile and mixtures thereof and
(v) a dialkylaminoalkyl acrylate, dialkylaminoalkyl methacrylate, diallyldimethylammonium chloride, dialkylaminoalkylacrylamide, dialkylaminoalkylmethacrylamide, acrylic acid, methacrylic acid, itaconic acid, maleic acid, fumaric acid, crotonic acid and mixtures thereof.

14. The paper size mixture according to claim 1, which comprises, as component (b), an aqueous dispersion of an emulsion polymer which is prepared by polymerization of ethylenically unsaturated monomers in the presence of a degraded starch.

15. The paper size mixture according to claim 1, which comprises, as component (b), an aqueous dispersion of an emulsion polymer which is prepared by free radical polymerization of
(iv) at least one alkyl acrylate, alkyl methacrylate, vinyl ester of saturated carboxylic acids having 1 to 20 carbon atoms, vinylaromatic having up to 20 carbon atoms, ethylenically unsaturated nitrile, vinyl halide, vinyl ether of alcohols comprising 1 to 10 carbon atoms, aliphatic hydrocarbon having 2 to 8 carbon atoms and one or two double bonds and
(v) optionally, at least one cationic and/or at least one anionic monomer
in the presence of at least one low molecular weight prepolymer as an emulsifier.

16. The paper size mixture according to claim 1, which comprises, as component (b), at least one water-soluble or water-dispersible polymer which does not have a dispersing effect and is selected from the group consisting of the polymers comprising ethyleneimine units, polymers comprising vinylamine units, polyurethanes, polyesters, ethylene copolymers with anionic and/or cationic monomers and mixtures thereof.

17. A size for the engine sizing and surface sizing of paper and paper products comprising the paper size mixtures according to claim 1.
